(19) United States
(12) Patent Application Publication
(10) Pub. No.: US 2026/0065794 A1
(43) Pub. Date: Mar. 5, 2026

(54) SYSTEM AND METHOD FOR PRECISION COCKTAIL CRAFTING USING A MULTI-COMPARTMENT CONTAINER

(71) Applicant: Oluwarotimi Fashanu, Rockville, MD (US)

(72) Inventor: Oluwarotimi Fashanu, Rockville, MD (US)

(73) Assignee: Bartifier LLC, Rockville, MD (US)

(21) Appl. No.: 18/822,270

(22) Filed: Sep. 1, 2024

(51) Int. Cl. G09B 5/02; A47J 43/27; B65D 1/26; B65D 25/04

(52) U.S. Cl. CPC G09B 5/02; A47J 43/27; B65D 1/26; B65D 25/04

(57) ABSTRACT

A method and system designed to facilitate the process of cocktail creation by systematically arranging ingredients within specified compartments of a multi-compartment container. The system uses containers to store various liquids in predetermined proportions relative to each other. It is coupled with a computing device that is programmed to guide users on the placement of ingredients within the appropriate compartments. The computing device sequentially presents each ingredient from the recipe, alongside a display that indicates the corresponding compartment(s) designated for the placement of each ingredient.

### FIELD OF THE INVENTION

The field of the invention pertains specifically to the art of cocktail crafting. It employs a multi-compartment container in conjunction with a sophisticated digital guidance system, which aids users in the accurate measurement and combination of ingredients, thereby enhancing the overall cocktail preparation experience.

### BACKGROUND

The traditional methods of cocktail crafting often involve following detailed recipes that specify the volume of each ingredient to be added to a container. This process typically requires individuals to use a single measuring cup, repeatedly portioning out each ingredient and then transferring them to the glass.

A person who wants to make cocktails or mocktails must have many recipes committed to memory and have multiple sizes of measuring cups on hand to properly craft the desired beverages. Such a method is not only laborious but also involves numerous back-and-forth steps, increasing the likelihood of errors and inefficiencies. By employing a multi-partitioned container capable of holding liquids in predetermined proportions within each partition, our invention aims to streamline the cocktail creation process, enabling swift and precise cocktail crafting with minimal effort.

Prior art devices for cocktail crafting require the user to purchase expensive capsules. The specific capsule for the desired cocktail/mocktail must be purchased, driving up the cost of having the ability to craft a variety of cocktails/mocktails. The end user of prior art devices becomes locked in the capsule-type ecosystem and cannot use their preferred ingredients. Moreover, the onboard technology makes the purchase of such a device an expensive endeavor. Cleaning such a device, and making substantial changes to cocktail recipes can be extremely challenging at best, but more likely, impossible. The implementations disclosed herein overcome the prior art shortcomings.

### SUMMARY

The Cocktail Making System disclosed herein solves the problems of the prior art methods of cocktail/mocktail crafting. A multi-compartment container for preparing the cocktails combined with the digital guidance system, guides an end user in the art of cocktail crafting without the expense of a technology-heavy machine. The multi-compartment container can be easily cleaned, and the end user will have the ability to use their own preferred ingredients instead of needing to frequently purchase pods, or capsules. The digital guidance system can be easily updated to include a growing library of cocktail/mocktail recipes for use with the Cocktail Making System.

### BRIEF DESCRIPTION OF THE DRAWINGS

The invention is exemplified through various embodiments depicted in multiple figures. These figures include detailed illustrations of the multi-compartment container and the digital guidance system, each demonstrating specific features and functionalities that contribute to the innovation.

FIG. 1: Shows an embodiment of the multi-compartment container 100, and the digital guidance system 101.

FIG. 2 is a top view of an implementation of the multi-compartment container 100.

FIG. 3 is a top view of an implementation of the multi-compartment container.

FIG. 4 is an implementation of the digital guidance app 101.

FIG. 5 is an implementation of the digital guidance app 101.

FIG. 6 is an implementation of the digital guidance app 101.

FIGS. 7-16 are an implementation of steps in a process of mixing a drink using the multi-compartment container and digital guidance app 101.

### DETAILED DESCRIPTION

Where appropriate, similar reference numerals and characters are employed to denote identical, corresponding, or analogous components across different figures. The illustrations accompanying this disclosure are not drawn to precise dimensional accuracy.

Not all routine features of the implementations described herein are explicitly depicted and delineated. It is to be understood that in the actualization of any such implementation, a multitude of implementation-specific decisions must be made to attain the disclosure's specific objectives, encompassing adherence to application and business-related constraints. These particular objectives will vary from one implementation to another.

Furthermore, it is acknowledged that the development of such an effort might be intricate and time-consuming; however, it remains an ordinary undertaking for those possessing ordinary skill in the art, leveraging the insights provided in this disclosure.

Terms such as “bottom”, “lower,” “above,” “below,” “in front of,”, “top”, “behind,” etc., is employed to depict the positions and/or orientations of different components within the embodiment concerning each other, as illustrated in the various Figures. These terms are not meant to impose restrictions on any specific position and/or orientation of any embodiment of the device concerning any external reference point.

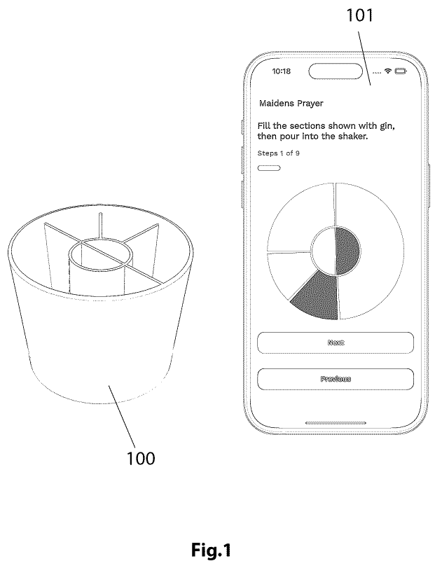

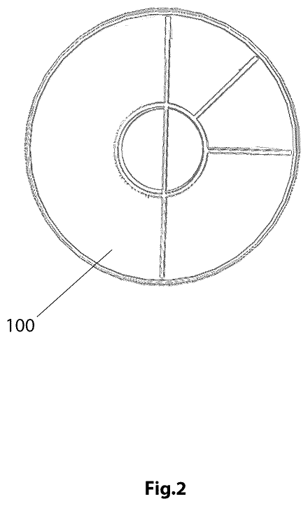

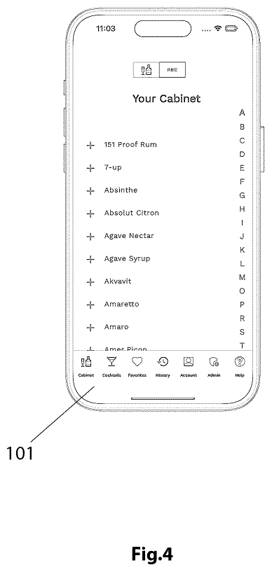

This multi-compartment cocktail maker is a noteworthy advancement in smart mixology. As illustrated in the embodiments of FIG. 1 and FIG. 2, the beverage-making system includes a multi-compartment container 100 and the digital guidance system 101 that outputs instructions. In some embodiments, the digital guidance system may be a mobile application to get user input as the user navigates and makes selections. The digital guidance system 101 provides step-by-step instructions on what ingredients should be placed in which partitions of the container. As shown in FIG. 4, a user can input the ingredients they have available into the digital guidance system by clicking on the plus sign. The digital guidance system can suggest cocktails or mocktails that a user can craft based on their available ingredients.

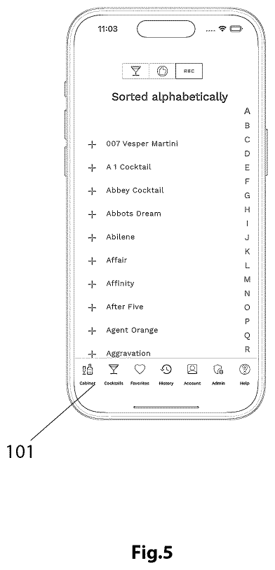

As shown in FIG. 5, a user can select the cocktails/mocktails they like by clicking on the plus sign in the digital guidance system. They can also click on the name of the cocktail to go to a detailed view of the cocktail. The user can select how many cups of the cocktail they would like to make. In other words, the digital guidance system will provide directions for crafting cocktails/mocktails and adjust partitions based on how many cups the user wants to make.

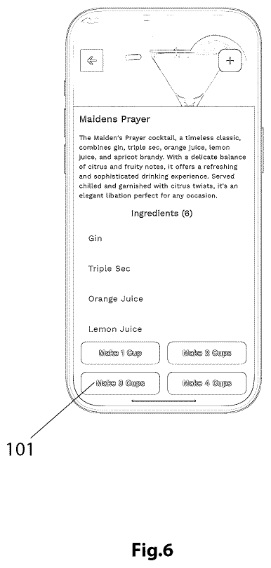

A user can see a detailed view of the cocktail, including a brief description, ingredients needed, and buttons to click to make various quantities of cocktail, as shown in FIG. 6. User favorites can be stored and a history of cocktails you have made is also stored.

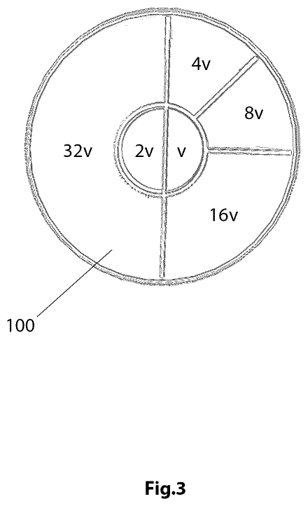

FIG. 3: Shows the top view of the multi-compartment container 100, showcasing an implementation of the partitioning of the compartments. It also shows the relative volume of liquid that can be put into each compartment. If the smallest partition can hold volume of v, the other partitions can hold volumes of 2v, 4v, 8v, 16v and 32v. When v is ¼ oz, the partitions would be ¼ oz, ½ oz, 1 oz, 2 oz, 4 oz and 8 oz, this would allow a user make 1 to 4 cups of cocktails.

The volume, v, of the multi-compartment container 100 can be varied in other implementations to suit the needs of the user. In a non-limiting example, setting v to ¼ oz would result in a small multi-compartment container 101 that might be used to mix 1 to 4 servings, while a larger size multi-compartment container where v is set to 1 oz might be more suitable for making 4 to 16 cups of cocktails for larger groups.

In an embodiment, this smart cocktail maker incorporates a digital guidance system 101. Button presses invoke functions like selecting, going back, and navigating. The digital guidance system 101 provides information for each ingredient, including which partition(s) the ingredients should be placed in the multi-compartment container 100.

To assist users in crafting a cocktail/mocktail, the multi-compartment cocktail device offers an organized view of tasks. Key functions of the multi-compartment cocktail device encompass:
Displaying ingredients and actions logically for recipe assembly.
Visualizing which partition(s) the current ingredient should be put in.
Guiding users to maintain proper proportions.

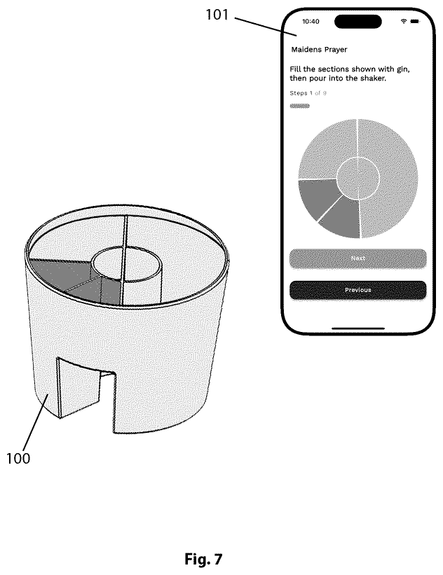

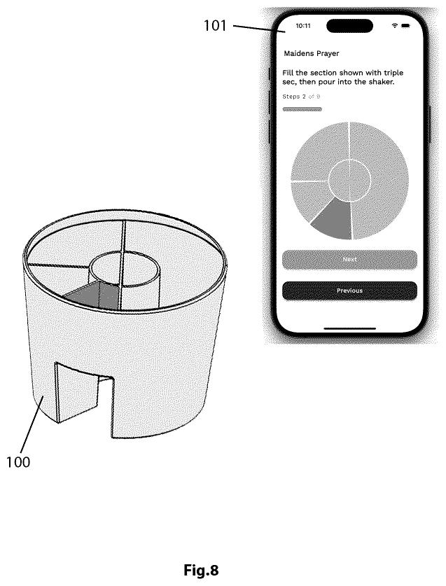

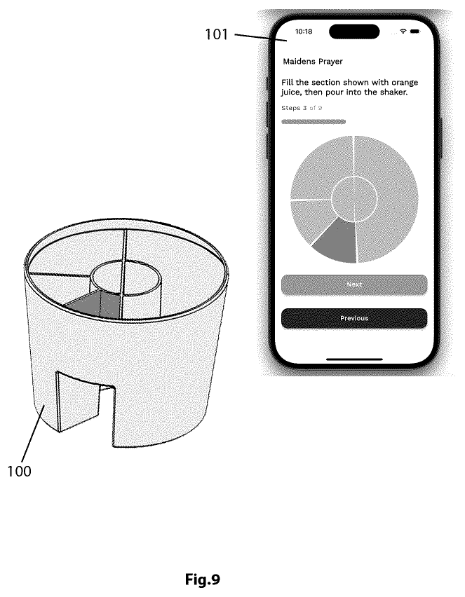

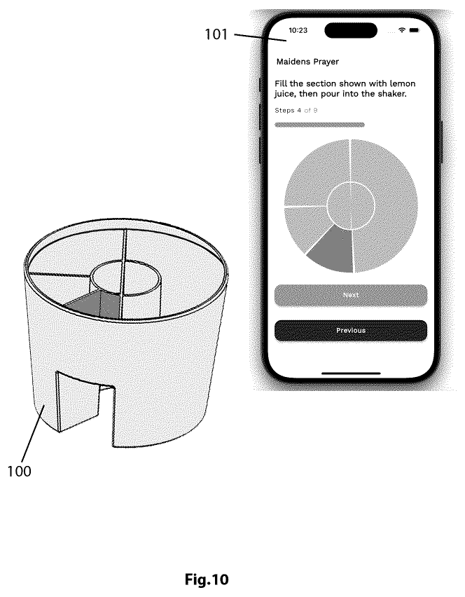

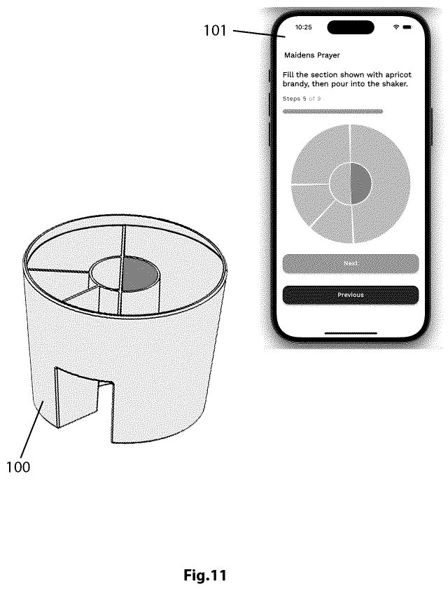

The multi-compartment cocktail device organizes ingredients and actions in a recipe logically and intuitively. FIGS. 7-11 illustrate how the digital guidance system shows which partition(s) to put each ingredient.

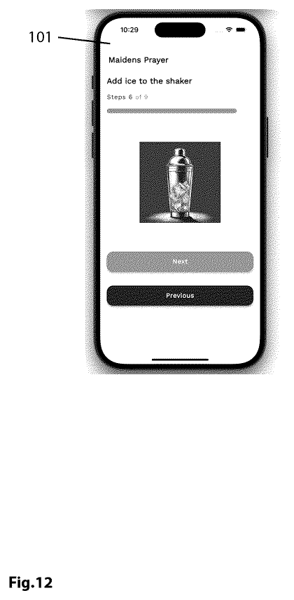

FIG. 12: Depicts guidance to the user to add ice to a cocktail shaker.

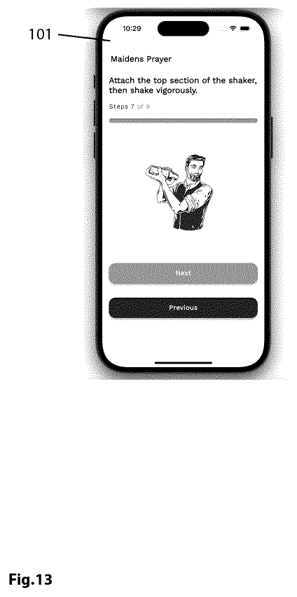

FIG. 13: Depicts guidance to the user to shake the cocktail shaker.

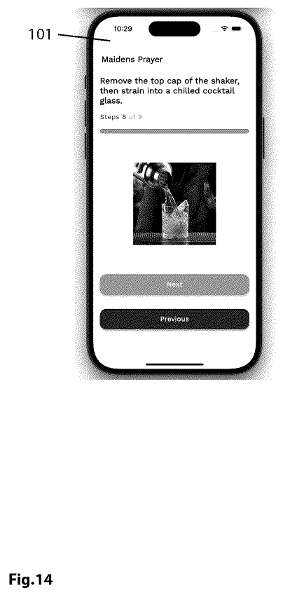

FIG. 14: Depicts guidance to the user to remove the cap from the top of a cocktail shaker and then pour their cocktail into a glass.

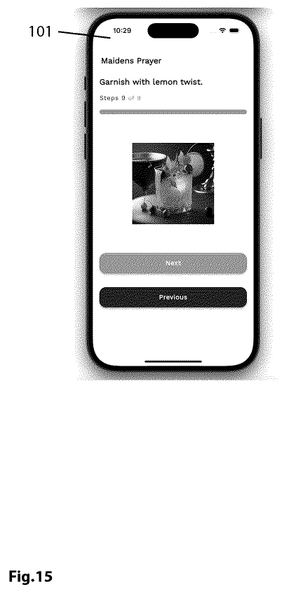

FIG. 15: Depicts the recommendation to the user to place a garnish.

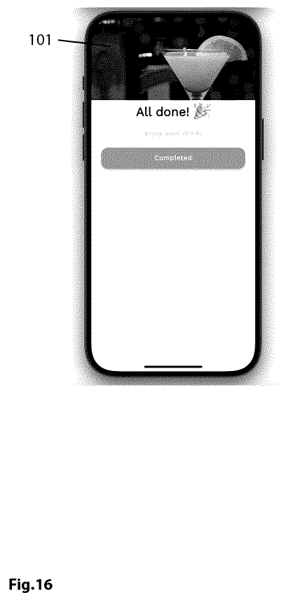

FIG. 16 shows a completed ingredient step. The multi-compartment cocktail device thus ensures a user-friendly, adaptable, and visually informative approach to recipe assembly and measurement, promoting an efficient and enjoyable mixology experience.

The multi-compartment container can have various sizes, to allow for the creation of more cocktails. The multi-compartment container can be further scaled up to create cocktails for larger groups or parties. It is within the scope of the invention for the size of the multi-compartment container to be increased. An end-user would need to input the size of the multi-compartment container into the digital guidance app.

1. A cocktail-making system comprising:
a multi-compartment container; and
a digital guidance system.

2. The cocktail-making system of claim 1, wherein the digital guidance system displays sequential steps of adding ingredients to the multi-compartment container.

3. The cocktail-making system of claim 2, wherein the digital guidance system graphically displays which compartment of the multi-compartment container to add the ingredients.

4. The cocktail-making system of claim 3, wherein the digital guidance system displays when the ingredients should be shaken together.

5. The cocktail-making system of claim 4, wherein the digital guidance system displays sequential steps of adding ingredients to the multi-compartment container.

6. The cocktail-making system of claim 5, wherein the digital guidance system graphically displays which compartment of the multi-compartment container to add the ingredients.

7. The cocktail-making system of claim 6, wherein the digital guidance system displays when the ingredients should be shaken together.

8. The cocktail-making system of claim 1, wherein the multi-compartment container includes at least two compartments.

9. The cocktail-making system of claim 1, wherein the multi-compartment container consists of six compartments.

10. The cocktail-making system of claim 1, wherein the multi-compartment container includes at least 6 compartments.

11. A non-transitory computer-readable medium containing instructions for a method of assembling a cocktail, the method comprising:
displaying instructions on a screen to sequentially add predetermined ingredients to specified sections of a multi-compartment container.

12. The non-transitory computer-readable medium of claim 11, further comprising the step of requesting a user to enter the size of the multi-compartment container being used.

13. A multi-compartment container for use in a cocktail-making system, the multi-compartment container comprising:
at least one partition for dividing the multi-compartment container into sections that are capable of storing beverages.

14. The multi-compartment container of claim 13, wherein the multi-compartment container has at least two sections.

15. The multi-compartment container of claim 13, wherein the multi-compartment container consists of six sections.

16. The multi-compartment container of claim 13, wherein the multi-compartment container has at least six sections.
